(19) United States
(12) Patent Application Publication
(10) Pub. No.: US 2022/0129317 A1
(43) Pub. Date: Apr. 28, 2022

(54) MANAGING CHANGES TO SHARED CODE RESOURCES

(71) Applicant: EMC IP Holding Company LLC, Hopkinton, MA (US)

(72) Inventors: Vincent Thyng, Des Moines, WA (US); Tom Zhengchu Liu, Taipei City (TW)

(21) Appl. No.: 17/082,552

(22) Filed: Oct. 28, 2020

(51) Int. Cl. G06F 9/50

(52) U.S. Cl. CPC G06F 9/5027

(57) ABSTRACT

A method of managing configuration dependencies in distributed applications is described, comprising identifying, by a first device comprising a first processor, a storage data structure, with the storage data structure storing information corresponding to a group of code resources for use by services executable by a second device comprising a second processor. The method can further comprise, based on deployment of a change to a first code resource of the group of code resources, searching, by the first device, the storage data structure to identify a first service that was implicated by the change to the first code resource. Further, the message can comprise, based the first service being implicated, determining, by the first device, the first service has a dependency on the change to the first code resource.

### TECHNICAL FIELD

The subject application generally relates to computer applications, and, for example, to maintaining distributed computer applications, and related embodiments.

### BACKGROUND

Modern configuration management solutions can facilitate the reuse of configurations for many different applications. In some situations, this reuse results in multiple applications relying upon the same code resource for certain configuration elements, e.g., configurations dependent upon other configurations. Because of the complexity of some distributed systems, the dependencies can, over time, become very complex.

Problems can occur when changes are made to a configuration that is depended on by other configurations and the extent of the impact of the change is unclear. Based on this, changes to configurations can occur without the extent of the change being known.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

According to an embodiment, a system can comprise a processor and a memory that can store executable instructions that, when executed by the processor, can execute computer executable components stored in the memory, including a deployer component that deploys a change to a code resource comprised in a list of code resources for use by services executable by a second device comprising a second processor. An additional component can include a dependency lister that can receive an indication that a service is implicated by the change to the code resource, wherein, in response to deployment of the change to the code resource of the code resources, the second device searched the list of code resources to identify the service implicated by the change to the code resource. In an example implementation of the system described above, the second device searched the list of code resources comprised in a configuration management code base. Further, the code resources referenced by the list of code resources correspond to resource files stored in a computer file system, with the second device searching the configuration management code base to identify a resource file corresponding to the code resource.

In an additional or other implementation, the computer file system of the previous example can comprise a Linux computer operating system, and searching to identify the service implicated by the change can be based on a Linux audit system of the Linux computer operating system.

In additional embodiments of the system, the indication that the service is implicated by the change to the code resource can comprise an indication that the service comprises a configuration that depends on code of the code resource that was changed by the change.

One or more additional embodiments can provide a method comprising identifying, by a first device comprising a first processor, a storage data structure, wherein the storage data structure stores information corresponding to a group of code resources for use by services executable by a second device comprising a second processor. The method can further comprise, based on deployment of a change to a first code resource of the group of code resources, searching, by the first device, the storage data structure to identify a first service that was implicated by the change to the first code resource. Further, the method can include, based on the first service being implicated, determining, by the first device, the first service has a dependency on the change to the first code resource.

In additional embodiments of the method, the first service dependency on the change to the first code resource can be that the first service is configured to depend on code of the first code resource that was changed by the change to the first code resource. In an implementation, the storage data structure describes a configuration management code base. In another variation, the group of code resources can be stored in a computer file system, with the code resources corresponding to resource files stored in the computer file system, and with the first code resource corresponding to a first resource file of the group of resource files. An example operating system for implementation of one or more embodiments can include the Linux operating system, and, in this example, searching for the first service can be based on a Linux audit system.

In additional embodiments of the method described above, the method can further include generating, by the first device, dependency information corresponding to a dependency relationships between the first service and the first code resource, wherein the generating is based on monitoring code resources accessed by operation of the first service, storing, by the first device, the dependency information in the storage data structure. In an implementation, monitoring the code resources accessed can comprise monitoring resource files accessed by operation of the first service.

In additional embodiments of the method described above, the method can further include, based on a second service being implicated by the change to the first code resource filtering, by the first device, the first code resource from the group of code resources. In some embodiments, this filtering of the first code resource from the group of code resources can depend upon a threshold number of services depending upon the first code resource. In other implementations of the method in a computer operating system environment, the first device can determine that the code resources of the group of code resources are able to be accessed. Additionally, the method can further include identifying, by the first device, a change in composition of the group of code resources, and updating the storage data structure to identify services that are implicated by the change in composition.

Additional embodiments can comprise a machine-readable storage medium comprising executable instructions that, when executed by a processor of a computing device, facilitate performance of operations, the operations comprising identifying a storage data structure stored on storage equipment, wherein the storage data structure stores information comprising a group of code resources for use by services executable by a second device comprising a second processor, and based on deployment of a change to a code resource of the code resources, searching the services executable by the second device to identify a service that was implicated by the change to the code resource. The operations can further comprise, based on the service being implicated, determining the service has a dependency on the change to the code resource.

In an implementation of the machine-readable storage medium discussed above, the service dependency on the change can be that the service comprises a configuration that depends on code of the code resource that was changed by the change. In additional examples, the non-transitory machine-readable medium can include operations where code resources referenced by the group of code resources correspond to resource files stored in a computer file system, and the searching the services comprises searching a configuration management code base to identify a service file corresponding to the service. In a variation of these embodiments, the computer file system can be a Linux operating system, and searching to identify the service implicated by the change can be performed by a Linux audit system of the Linux operating system.

Other embodiments may become apparent from the following detailed description when taken in conjunction with the drawings.

### BRIEF DESCRIPTION OF THE DRAWINGS

The technology described herein is illustrated by way of example and not limited in the accompanying figures in which like reference numerals indicate similar elements, and in which:

FIG. 1 illustrates a block diagram of an example, non-limiting system that can facilitate managing dependencies in distributed applications, in accordance with various aspects and implementations of the subject disclosure.

FIG. 2 illustrates a block diagram of a system that can facilitate managing dependencies in distributed applications, in accordance with one or more embodiments.

FIG. 3 depicts a non-limiting diagram of a system where different blocks of code of a code resource reply upon different services of the group of services, in accordance with one or more embodiments.

FIG. 4 depicts a non-limiting system that includes a service monitor to monitor storage equipment, in accordance with one or more embodiments.

FIG. 5 depicts a non-limiting example system that includes multiple services depending upon a code resource from the group of code resources, in accordance with one or more embodiments.

FIG. 6 depicts a non-limiting example system where code resources are operating system files stored in subdirectories of an operating system, in accordance with one or more embodiments.

FIG. 7 is a flow diagram representing example operations of an example system comprising a deployer component, and a dependency lister component can facilitate managing configuration dependencies in distributed applications, in accordance with one or more embodiments.

FIG. 8 illustrates an example flow diagram for a method that can facilitate managing configuration dependencies in distributed applications, in accordance with one or more embodiments.

FIG. 9 depicts an example schematic block diagram of a computing environment with which the disclosed subject matter can interact.

FIG. 10 illustrates an example block diagram of a computing system operable to execute the disclosed systems and methods in accordance with various aspects and implementations of the subject disclosure.

### DETAILED DESCRIPTION

Various aspects described herein are generally directed towards facilitating managing configuration dependencies in distributed applications, in accordance with one or more embodiments. As will be understood, the implementation(s) described herein are non-limiting examples, and variations to the technology can be implemented.

Reference throughout this specification to “one embodiment,” “one or more embodiments,” “an embodiment,” “one implementation,” “an implementation,” etc. means that a particular feature, structure, or characteristic described in connection with the embodiment/implementation is included in at least one embodiment/implementation.

Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

The computer processing systems, computer-implemented methods, apparatus and/or computer program products described herein can employ hardware and/or software to solve problems that are highly technical in nature (e.g., rapid determination and dissemination of distributed configuration dependencies), that are not abstract and cannot be performed as a set of mental acts by a human. For example, a human, or even a plurality of humans cannot efficiently, accurately and effectively, collect, encode, and transfer configuration information for services of a distributed system, with the same level of accuracy and/or efficiency as the various embodiments described herein.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

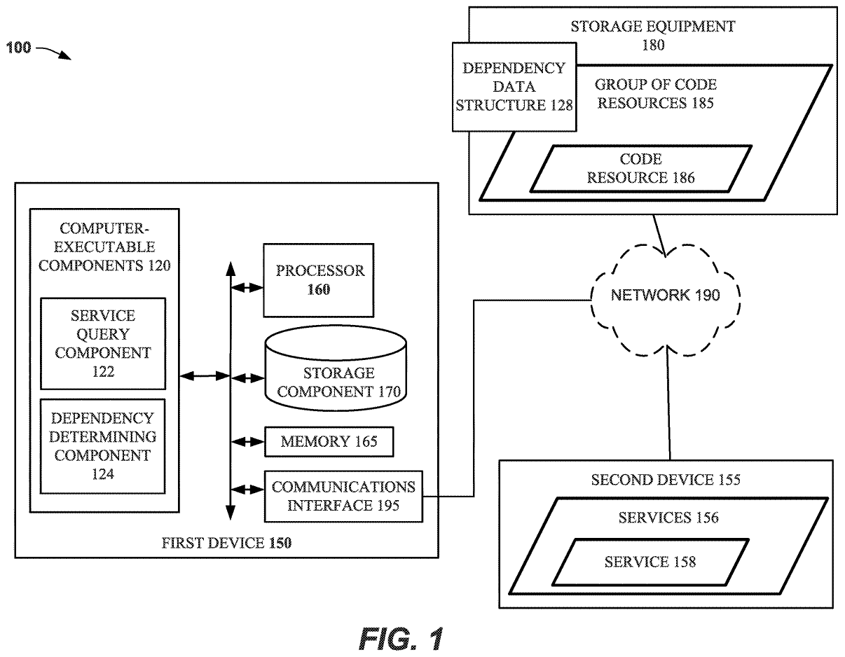

FIG. 1 illustrates a block diagram of an example, non-limiting system 100 that can facilitate managing configuration dependencies in distributed applications, in accordance with various aspects and implementations of the subject disclosure. Repetitive description of like elements and/or processes employed in respective embodiments is omitted for sake of brevity.

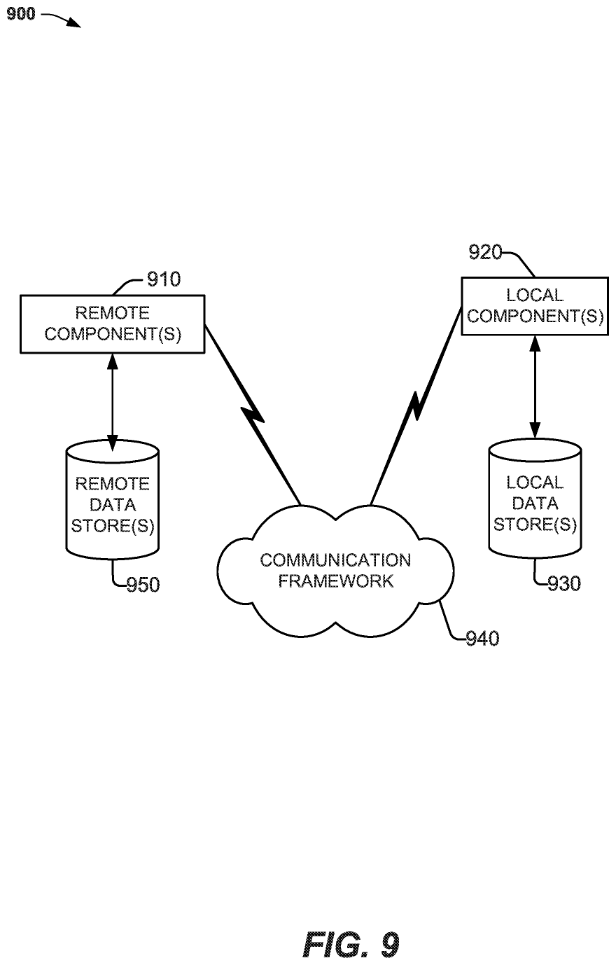

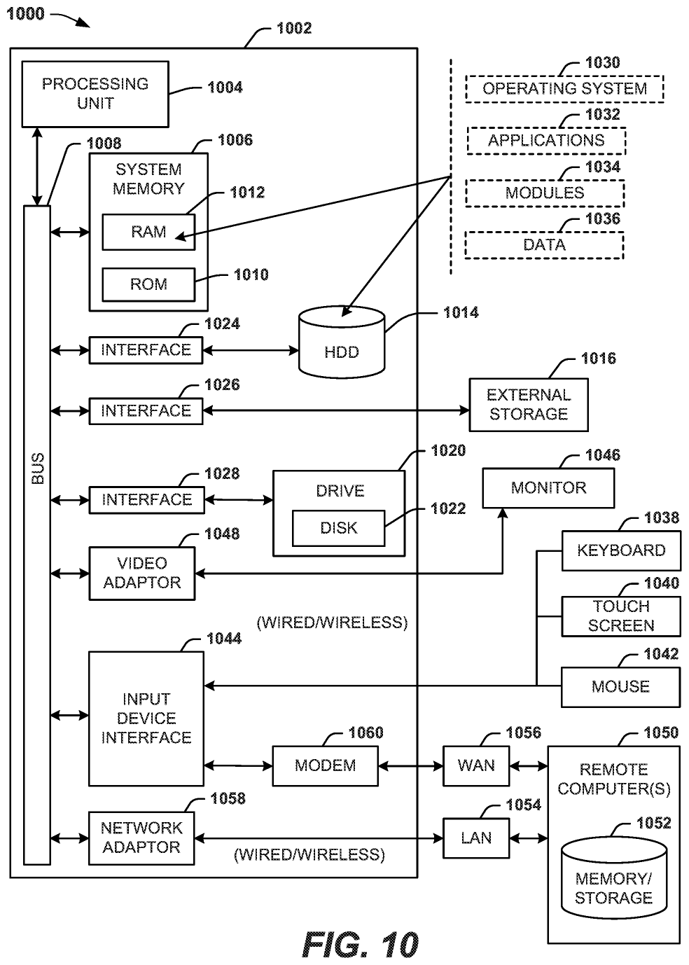

System 100 can include first device 150 communicatively coupled to second device 155, and storage equipment 180 via network 190. First device 150 can include computer-executable components 120, processor 160, storage component 170, memory 165, and communications interface 195. Examples of network 190 that can be used by one or more embodiments are discussed with FIGS. 9 and 10 below.

In one or more embodiments, memory 165 that can store computer executable components, and processor 160 can execute the computer executable components stored in the memory. As discussed further below with FIG. 10, in some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1016 and FIG. 10. Such examples of memory 165 can be employed to implement any embodiments of the subject disclosure.

According to multiple embodiments, processor 160 can comprise one or more types of processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like.

Computer-executable components 120 can include components described or suggested by one or more embodiments of system 100 and other systems discussed herein. For example, system 100 can be a system that implements a configuration management system for distributed applications, with computer-executable components 120 that include, but are not limited to, service query component 122, and dependency determining component 124.

As depicted, storage equipment 180 can include group of code resources 185 with one of the group of code resources being code resource 186. Second device 155 includes services 156, with service 158 being a first service discussed herein. Generally speaking, in one or more embodiments, group of code resources 185 can store information describing a group of code resources for use by services 156, and a dependency between code resource 186 and service 158 can be discovered (e.g., by dependency determining component 124) based on querying of storage equipment 180 by service query component 122. In additional embodiments, dependencies can also be discovered during use of services 158, and stored for use in dependency data structure 128.

In one or more embodiments, by service query component 122 can identify a storage data structure for use establishing dependency relationships between code resource 186 and services 156. For example, as stored on storage equipment 180, dependency data structure 128 is a storage data structure that can code resources for use by services 156 executable by other system devices (not shown).

In one or more embodiments, based on deployment of a change to a first code resource 186 of the group of code resources stored in group of code resources 185, searching, service query component 122 of first device 150, to identify service 158 that was implicated by the change to code resource 186. As discussed further below, an example implication of service 158 can be a dependency upon code resource 186, e.g., service 158 uses a configuration that is specified by a part of code resource 186.

Continuing this example, based on the service 158 being implicated, dependency determining component 124 of first device 150 can determine that the first service has a dependency on the change to the first code resource, e.g., service 158 depends on the changed portion of code resource 186.

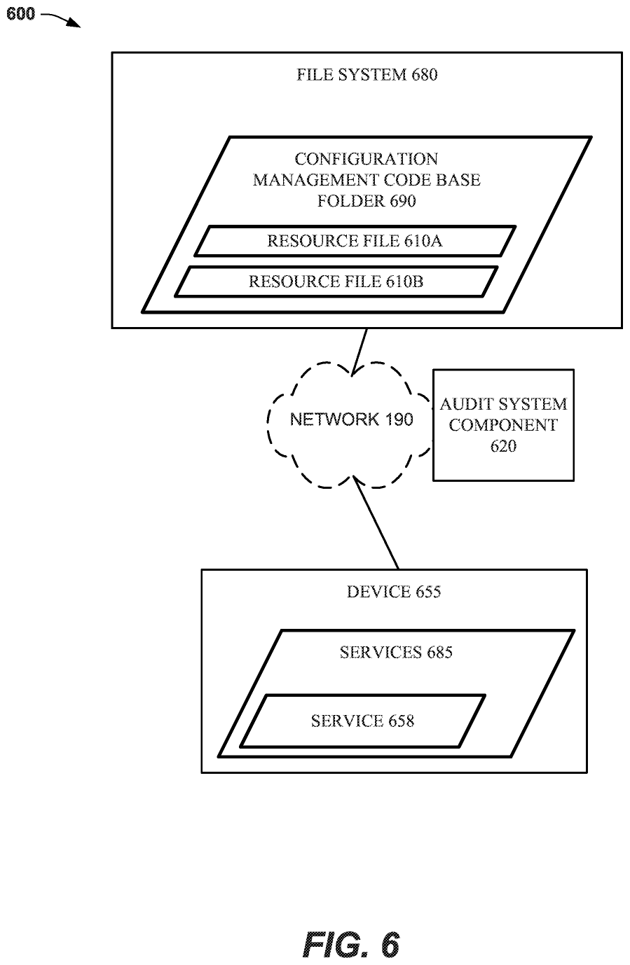

It should be noted that, as discussed with many different examples herein, while storage equipment 180 stores information about code resource 186, the code resources can be stored in other locations accessible by network 190. In other examples however, code resource 186 represents the resources accessed via network 190 based on dependencies of services 156. Illustrating this, in an example discussed with FIG. 6 below, group of code resources 185 can be a file system directory and code resource 186 can be files accessed via network 190.

Example systems with distributed applications which can employ one or more of the approaches described with embodiments herein include, but are not limited to POWERSCALE CLOUD STORAGE®, an example network attached storage (NAS) platform provided by DELL EMC, Inc.

As will be understood, the implementation(s) described herein are non- limiting examples, and variations to the technology can be implemented. As such, any of the embodiments, aspects, concepts, structures, functionalities, implementations and/or examples described herein are non-limiting, and the technology may be used in various ways that provide benefits and advantages in distributed systems technology in general, both for existing technologies and technologies in this area that are yet to be developed.

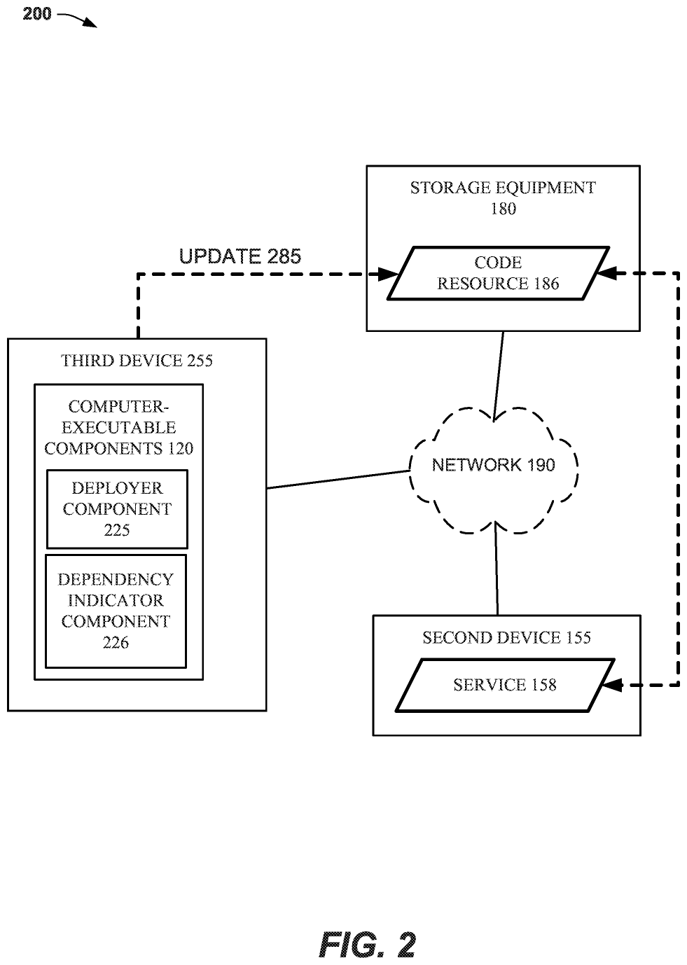

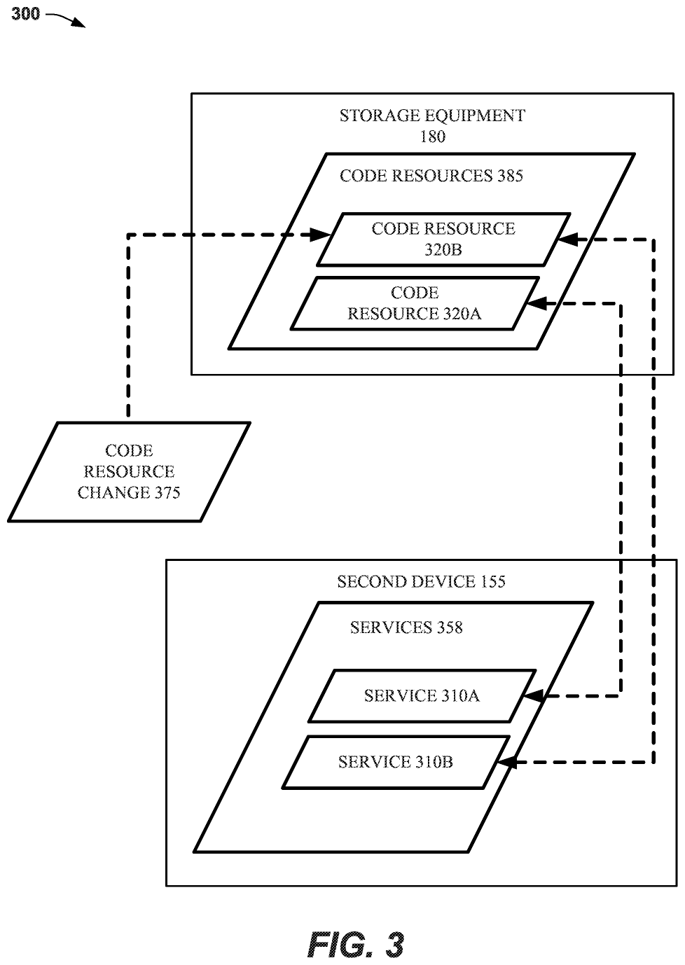

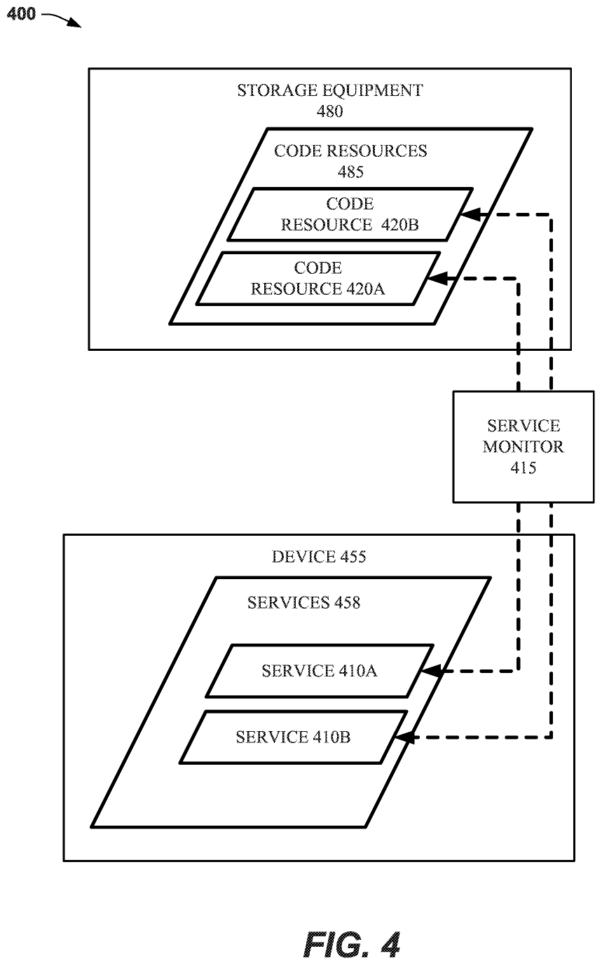

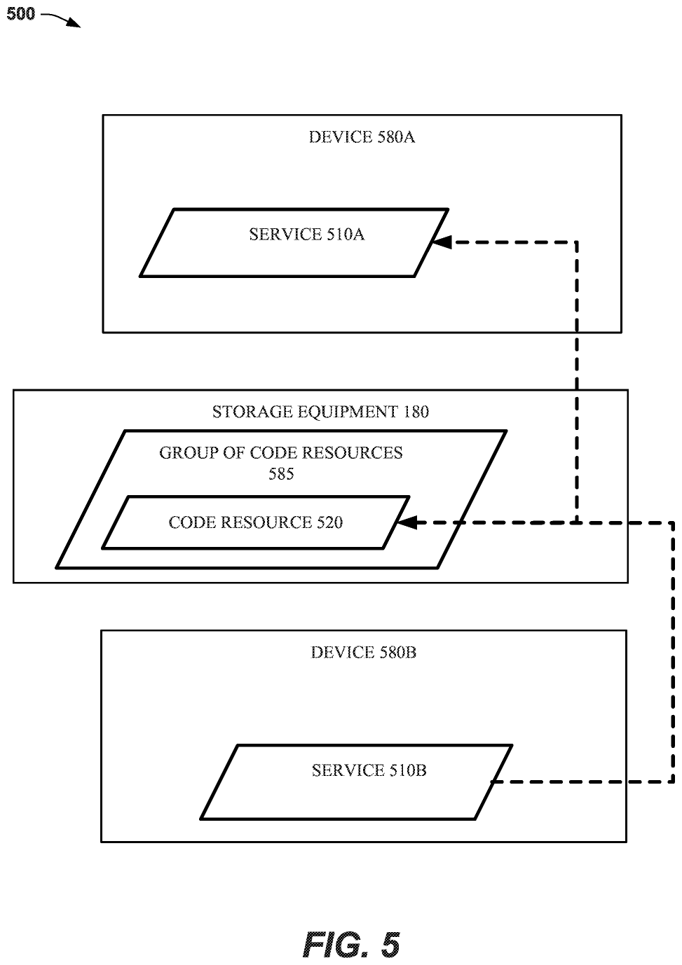

As discussed further below, FIG. 2 depicts embodiments from a perspective of the changes to code resources, FIG. 3 depicts changes to one code resource of a group of code resources, FIG. 4 depicts a service monitor that can detect the service dependencies, FIG. 5 depicts multiple services relying upon the same code resources, and as noted above, FIG. 6 depicts embodiments implemented in an operating system environment. FIG. 5 also provides example relationships between example services and example code resources.

FIG. 2 illustrates a block diagram of a system 200 that can facilitate managing dependencies in distributed applications, in accordance with one or more embodiments. Repetitive description of like elements and/or processes employed in respective embodiments is omitted for sake of brevity.

System 200 includes third device 255 coupled via network 190 to storage equipment 180 and second device 155. Third device 255 includes computer executable components 120. Computer executable components can include deployer component 225 and dependency indicator component 226.

As discussed further herein, in this example, service 158 is an application that depends on a configuration stored, for sharing, in storage equipment 180, e.g., code resource 186. In one or more embodiments, deployer component 225 can deploy a change to update 285 a code resource, e.g., code resource 186. In this example, as discussed with FIG. 1 above, a dependency indicator component 226 (also termed a dependency lister component herein) can receive an indication that service 158 is implicated by the update 285 to code resource 186, e.g., from dependency determining component 124 on first device 150 discussed with FIG. 1 above. In one or more embodiments, the indication was received based on a search of the list of services (e.g., dependency data structure 128) to identify service 158 as implicated by the change to update 285 code resource 186. This search can have been triggered by the deployment by deployer component 225 of the change to code resource 186 of the code resources.

FIG. 3 depicts a non-limiting diagram of a system 300 where different blocks of code of a code resource reply upon different services of the group of services, in accordance with one or more embodiments. For purposes of brevity, description of like elements and/or processes employed in other embodiments is omitted. System 300 can include storage equipment 180 and second device 155, with code resource 320B being updated by code resource change 375. Code resources 385 comprises multiple code resources 320A-B, and services 358 includes services 310A-B.

As depicted, services 310A-B rely upon code resources 320A-B respectively. As further depicted, instead of updating all code resources 385, code resource change 375 updates code resource 320B, but not code resource 320A. In one or more embodiments, resources of system 300 (e.g., service query component 122 of system 100) can identify, based on code resource 320B being updated, that the services implicated by this update include service 310B. One approach where service 310B can be identified by embodiments is to query dependency data structure 128. As described with FIG. 4 below, one or more embodiments can populate dependency data structure with dependencies of services 310A-B in a variety of ways.

FIG. 4 depicts a non-limiting system 400 that includes a service monitor to monitor storage equipment 180, in accordance with one or more embodiments. For purposes of brevity, description of like elements and/or processes employed in other embodiments is omitted.

As depicted, system 400 can include storage equipment 480 and device 455, including code resources 485 and services 458 respectively. Code resources 485 comprises multiple code resources 420A-B, that respectively are depended upon by services 458 including services 410A-B.

As discussed with FIG. 3 above, different embodiments can identify service 458 dependencies upon code resources 485, in different ways. One approach, depicted in FIG. 4, includes using service monitor 415 to monitor references by services 410A-B to code resources 420A-B, e.g., an access of a code resource by a service can be logged and a link can be stored in dependency data structure 128.

In a variation of this approach, discussed with FIG. 6 below, one or more embodiments can implement code resources 420A-B as files in a file system, with code resources 485 group corresponding to a designated subdirectory for code resources. As described further below, in this example, service monitor 415 can be implemented using operating system auditing components, e.g., to monitor the access of code resources 420A-B.

FIG. 5 depicts a non-limiting example system 500 that includes multiple services depending upon a code resource from the group of code resources, in accordance with one or more embodiments. For purposes of brevity, description of like elements and/or processes employed in other embodiments is omitted.

System 500 includes devices 580A-B, with services 510A-B respectively, and storage equipment 180, with code resource 520. Example devices that can deploy changes to code resource 520 (e.g., deployer component 225) or utilize services 510A-B (e.g., as components of a system with shared configuration files) are not depicted in FIG. 5.

In an example, services 510A-B can be different instances of a web server application. In example implementations, web server application services 510A-B each require configuration files to specify aspects of their respective operations, e.g., setting directory structures, uniform resource locator (URL) parameters, and configuration management options. As described in the background above, modern systems can share configuration settings, e.g., by referencing external configuration files for all or part of the configuration information. In this example, service 510A-B can each have local configuration files (e.g., specific to websites hosted by the respective servers), but also reference a shared configuration file or files, e.g., code resource 520.

One way this can be implemented is by using an “include” directive referencing one or more additional configuration files. One having skill in the relevant art(s), given the description herein, would appreciate that instead or in addition to, the use of configuration files, a database or registry system can also be used with one or more embodiments.

Continuing this example, when code resource 520 is to be modified (e.g., by deployer component 225), before a production deployment occurs, one or more embodiments can be used to identify sets of services 510A-B that can be implicated by the change, e.g., depend on the configuration file modified.

As described above, services (e.g., all potentially dependent services) can be detected and highlighted as implicated or not by a change to code resource 520. In a variation however, changes to certain code resources 520 can be identified as widely affecting services throughout an organization. When these code resources are detected, rather than continue processing and specifying (potentially large) numbers of implicated services, one or more embodiments can filter out these code resources from analysis, e.g., on change submission, files that are accessed by all configurations can be filtered out, as these are not likely to help determine services impacted. One approach to this limiting of the detection of widely used configuration files can be based on a threshold number of services depending on the code resources.

FIG. 6 depicts a non-limiting example system 600 where code resources are operating system files stored in subdirectories of an operating system, in accordance with one or more embodiments. For purposes of brevity, description of like elements and/or processes employed in other embodiments is omitted.

As depicted, system 600 includes file system 680 connected to device 655 via network 190. File system 680 includes configuration management code base folder 690 holding resource files 610A-B. Device 665 stores a collection of services 685, with example service 658 being discussed herein.

In one or more embodiments, an audit system of an operating system can be used to monitor a configuration management system while processing a change set to automatically determine the files impacted by the change. In some implementations, this technique can result in list of resource files associated with a specific service, e.g., services that depend on particular resource files 610A-B. This list can be referenced later to determine which service or services should be tested for a given change.

In one or more embodiments, a configuration management code base (e.g., a storage data structure described in FIG. 1) can be a file system subdirectory holding code resource 186. In this example, service monitor 415 can monitor configuration management code base folder 690 for access to resource files 610A-B. Some operating systems have audit system components 620 that can monitor file access events. Based on detected events, services accessing the service files can be logged (e.g., in a service file list) and dependency data can be generated for resource files 610A-B, e.g., for use with processes described with other embodiments herein. Continuing this example, on change submission, the service file list can be referenced to determine which services 658 depend on resource files 610A-B.

In an alternative example approach to determining service dependencies, one or more embodiments can scan and parse aspects of services to identify upon which of resource files 610A-B the services depend. In an example implementation, service 658 may have a configuration file that uses an “include” directive to incorporate the configuration settings specified by resource file 610B. One or more embodiments can scan this file, and store this dependency for use by other processes described herein.

In an example operating system implementation, the computer file system can be implemented using a Linux operating system, establishing a dependency data structure 128 of service dependencies can be performed by Linux audit system capabilities.

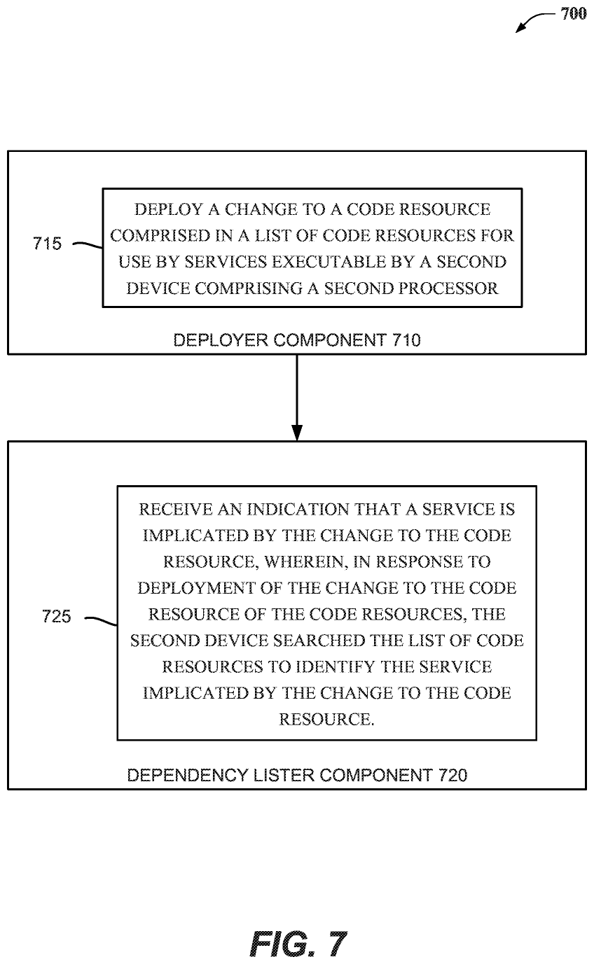

FIG. 7 is a flow diagram representing example operations of an example system 700 comprising deployer component 710, and dependency lister component 720 can facilitate managing configuration dependencies in distributed applications, in accordance with one or more embodiments. For purposes of brevity, description of like elements and/or processes employed in other embodiments is omitted.

In one or more embodiments, deployer component 710 can deploy a change to a code resource comprised in a list of code resources for use by services executable by a second device comprising a second processor. For example, deployer component 225 can deploy code resource change 375 to code resource 320B comprised in a list of code resources (e.g., dependency data structure 128) for use by a service, e.g., service 158.

Further, in one or more embodiments, dependency lister 720 can receive an indication that a service is implicated by the change to the code resource, and, in response to deployment of the change to the code resource of the code resources, the second device searched the list of code resources to identify the service implicated by the change to the code resource. For example, dependency lister 720 (e.g., dependency indicator component 226) can receive an indication that service 358 is implicated by code resource change 375 to code resource 320B, and, in response to deployment of the change to the code resource of the code resources, the second device searched the list of code resources (e.g., dependency data structure 128) to identify service 158 implicated by the change to the code resource.

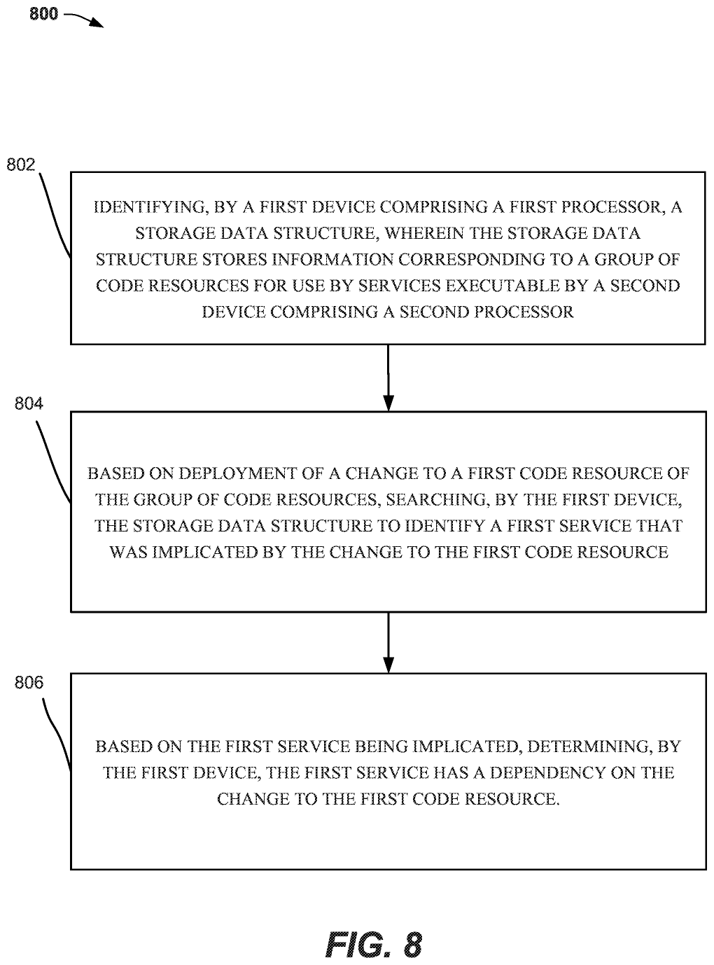

FIG. 8 illustrates an example flow diagram for a method 800 that can facilitate managing configuration dependencies in distributed applications, in accordance with one or more embodiments. For purposes of brevity, description of like elements and/or processes employed in other embodiments is omitted.

At element 802, method 800 can comprise identifying, by a first device comprising a first processor, a storage data structure, wherein the storage data structure stores information corresponding to a group of code resources for use by services executable by a second device comprising a second processor. For example, method 800 can comprise identifying, by first device 150 comprising processor 160, a storage data structure (e.g., dependency data structure 128), wherein the storage data structure stores information corresponding to a group of code resources 185 for use by services 156 executable by a second device comprising a second processor, e.g., accessible via network 190.

At element 804, method 800 can further comprise based on deployment of a change to a first code resource of the group of code resources, searching, by the first device, the storage data structure to identify a first service that was implicated by the change to the first code resource. For example, method 800 can further include, based on deployment of code resource change 375 to code resource 320B of the group of code resources 385, searching, by first device 150, dependency data structure 128 to identify a service 310B that was implicated by the change to the code resource 320B.

At element 806, method 800 can further comprise, based on the first service being implicated, determining, by the first device, the first service has a dependency on the change to the first code resource. For example, method 800 can comprise, based service 310B being implicated, determining, by first device 150, service 310B has a dependency on the change to the code resource 320B.

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit- switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct- wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media, device readable storage devices, or machine readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipments do not normally connect directly to the core networks of a large service provider but can be routed to the core by way of a switch or radio area network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) Radio Access Network (RAN) or GERAN; UMTS Terrestrial Radio Access Network (UTRAN); or LTE Advanced.

What has been described above includes examples of systems and methods illustrative of the disclosed subject matter. It is, of course, not possible to describe every combination of components or methods herein. One of ordinary skill in the art may recognize that many further combinations and permutations of the disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

While the various embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope of the various embodiments.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the embodiments are not to be limited to any single implementation, but rather is to be construed in breadth, spirit and scope in accordance with the appended claims.

What is claimed is:

1. A method, comprising:
identifying, by a first device comprising a first processor, a storage data structure, wherein the storage data structure stores information corresponding to a group of code resources for use by services executable by a second device comprising a second processor;
based on deployment of a change to a first code resource of the group of code resources, searching, by the first device, the storage data structure to identify a first service that was implicated by the change to the first code resource; and
based on the first service being implicated, determining, by the first device, the first service has a dependency on the change to the first code resource.

2. The method of claim 1, wherein the first service dependency on the change to the first code resource comprises that the first service is configured to depend on code of the first code resource that was changed by the change to the first code resource.

3. The method of claim 1, wherein the storage data structure describes a configuration management code base.

4. The method of claim 1, wherein the group of code resources comprises a computer file system, wherein the ones of the group of code resources comprise ones of a group of resource files stored in the computer file system, and wherein the first code resource corresponds to a first resource file of the group of resource files.

5. The method of claim 4, wherein the computer file system comprises a Linux operating system, and wherein searching for the first service is based on a Linux audit system.

6. The method of claim 5, further comprising:
generating, by the first device, dependency information corresponding to a dependency relationships between the first service and the first code resource, wherein the generating is based on monitoring code resources accessed by operation of the first service; and
storing, by the first device, the dependency information in the storage data structure.

7. The method of claim 6, wherein monitoring the code resources accessed comprises monitoring resource files accessed by operation of the first service.

8. The method of claim 1, further comprising, based on a second service being implicated by the change to the first code resource filtering, by the first device, the first code resource from the group of code resources.

9. The method of claim 8, wherein the filtering the first code resource from the group of code resources depends upon a threshold number of services depending upon the first code resource.

10. The method of claim 1, further comprising, determining, by the first device, determining that code resources of the group of code resources are able to be accessed.

11. The method of claim 1, further comprising, identifying, by the first device, a change in composition of the group of code resources, and updating the storage data structure to identify services that are implicated by the change in composition.

12. A first device, comprising:
a memory that stores computer executable components; and
a first processor that executes the computer executable components stored in the memory, wherein the computer executable components comprise:
a deployer that deploys a change to a code resource comprised in a list of code resources for use by services executable by a second device comprising a second processor, and
a dependency lister that receives an indication that a service is implicated by the change to the code resource, wherein, in response to deployment of the change to the code resource of the code resources, the second device searched the list of code resources to identify the service implicated by the change to the code resource.

13. The first device of claim 12, wherein the second device searched the list of code resources comprised in a configuration management code base.

14. The first device of claim 13, wherein the code resources referenced by the list of code resources correspond to resource files stored in a computer file system, and wherein the second device searched the configuration management code base to identify a resource file corresponding to the code resource.

15. The first device of claim 14, wherein the computer file system comprises a Linux operating system, and wherein searching to identify the service implicated by the change is based on a Linux audit system of the Linux operating system.

16. The first device of claim 12, wherein the indication that the service is implicated by the change to the code resource comprises an indication that the service comprises a configuration that depends on code of the code resource that was changed by the change.

17. A non-transitory machine-readable medium comprising executable instructions that, when executed by a first processor of a first device, facilitate performance of operations, the operations comprising:
identifying a storage data structure stored on storage equipment, wherein the storage data structure stores information comprising a group of code resources for use by services executable by a second device comprising a second processor;
based on deployment of a change to a code resource of the group of code resources, searching the services executable by the second device to identify a service that was implicated by the change to the code resource; and
based on the service being implicated, determining the service has a dependency on the change to the code resource.

18. The non-transitory machine-readable medium of claim 17, wherein the service dependency on the change comprises that the service comprises a configuration that depends on code of the code resource that was changed by the change.

19. The non-transitory machine-readable medium of claim 17, wherein code resources referenced by the group of code resources correspond to resource files stored in a computer file system, and wherein the searching the services executable by the second device comprises searching a configuration management code base to identify a service file corresponding to the service.

20. The non-transitory machine-readable medium of claim 19, wherein the computer file system comprises a Linux operating system, and wherein the searching to identify the service implicated by the change is based on a Linux audit system of the Linux operating system.
